(19) United States
(12) Patent Application Publication
(10) Pub. No.: US 2008/0062676 A1
(43) Pub. Date: Mar. 13, 2008

(54) HAND LIGHTING TOOL

(75) Inventor: Yukio MASUDA, Ichikawa-shi (JP)

Correspondence Address: HAMRE, SCHUMANN, MUELLER & LARSON, P.C., P.O. BOX 2902, MINNEAPOLIS, MN, 55402-0902, US

(73) Assignee: NANOTEC CO., LTD., CHIBA (JP)

(21) Appl. No.: 11/847,641

(22) Filed: Aug. 30, 2007

(30) Foreign Application Priority Data
Aug. 30, 2006 (JP) 2006-234233
Aug. 9, 2007 (JP) 2007-207798

(51) Int. Cl. F21V 21/08

(52) U.S. Cl. 362/103

(57) ABSTRACT

Provided is a hand lighting tool that allows lighting components to be easily attached to or detached from a user's fingers, allows the light emitted from the lighting components to converge on and efficiently illuminate the area around the user's hand, and also enables the user to work comfortably and efficiently.

A hand lighting tool 1 includes: a thumb wrapper 10 to be wrapped around a thumb so that it can be attached to or detached from the thumb; an index finger wrapper 20 to be wrapped around an index finger so that it can be attached to or detached from the index finger; an LED 30 placed on the outside surface of the thumb wrapper 10 at a position close to the index finger when the thumb wrapper 10 is wrapped around the thumb; an LED 40 placed on the outside surface of the index finger wrapper 20 at a position close to the thumb when the index finger wrapper 20 is wrapped around the index finger; and a power supply unit 50 electrically connected to the LEDs 30 and 40 for supplying an electric current to the LEDs 30 and 40.

### CROSS-REFERENCES TO RELATED APPLICATIONS

This application relates to and claims priority from Japanese Patent Application No. 2006-234233, filed on Aug. 30, 2006 and, Japanese Patent Application No. 2007-207798, filed on Aug. 9, 2007, the entire disclosures of which are incorporated herein by reference.

### BACKGROUND

1. Field of the Invention

The present invention relates to a hand lighting tool. In particular, the invention relates to a hand lighting tool that is attached to a user's hand to light up the area around the user's hand.

2. Description of Related Art

When a person works in a dark place, for example, outdoors at night, where no normal lighting equipment is installed, the conventional means that allows the person to do his work is, for example, holding a flashlight in his one hand to illuminate the area around his another hand, or mounting a headlamp on his head. If a flashlight is used to see the area around a person's hand when fishing at night, and if the person holds the flashlight in one hand, it will be difficult for him to fish (work) with both hands. If the person fishes (works) with a headlamp mounted on his head, the point illuminated by the light moves every time he moves his head. So, the light needs to stay focused on the person's hands every time his head moves, which is difficult. Also, if the light from the flashlight or the head lamp strikes other people, they may possibly find it annoying.

Therefore, a light glove was introduced: a glove with lights attached to its surface for illuminating the area around a user's hand as the user works (see Japanese Patent Laid-Open (Kokai) Publication No 2004-316050 and the Japanese translation of PCT international application (Tokuhyo) No. HEI 8-502666).

There is also a glove that has luminous elements on its respective fingertips, the luminous elements lighting up when the glove moves, and turning off when the glove stays still (see Japanese Utility Model Registration No. 3057778).

Furthermore, there is a grip strength control luminous tool including: a glove; luminous elements placed at the finger bases of the glove; a battery placed at the back of the glove; and pressure-sensitive conductive rubber placed at a position where the grip strength of the glove is applied. This grip strength control luminous tool is designed so that if the grip strength increases, the volume resistance value of the pressure-sensitive rubber decreases sharply and, therefore, the amount of an electric current supplied to the luminous elements increases, causing the light-emitting intensity to increase in proportion to the grip strength (see Japanese Patent Laid-Open (Kokai) Publication No. HEI 7-323097).

There is also a glove that has a pocket on at least one finger of the glove, and a lighting device is attached to the inside of the pocket so that the lighting device can be freely detached from the pocket (see Japanese Utility Model Registration No. 3114125).

The gloves with the lighting function (lights) described in Japanese Patent Laid-Open (Kokai) Publication No. 2004-316050, the Japanese translation of PCT international application (Tokuhyo) No. HEI 8-502666, Japanese Utility Model Registration No. 3057778, and Japanese Patent Laid-Open (Kokai) Publication No. HEI 7-323097 are configured so that the lighting components such as fairy lights or light-emitting diodes (LEDs) are attached to the finger parts of the gloves. As a result, when a user wants to keep the lighting components away from his fingers, for example, when washing his hands, it is necessary to take off the entire glove, which may be bothersome to the user.

In the glove with the lighting function (lights) described in the Japanese Utility Model Registration No. 3114125, the lighting component is attached to the inside of the pocket provided at the finger part of the glove so that the lighting device can be freely detached from the pocket. As a result, if the user wants to keep the lighting component away from his fingers, he can do so by taking the lighting component out of the pocket. However, there is a possibility that the lighting component taken out of the pocket may be lost.

Furthermore, in the gloves with the lighting function (lights) described in the five patent documents mentioned above, the lighting components such as lights are placed in substantially the same plane as the back of the glove. As a result, the light is emitted outwards away from a user's hand and it is difficult to make the light converge on the area around the user's hand. Also, these gloves with the lighting function (lights) are configured to cover the entire fingertips, and the lighting components such as lights are placed on the gloves having the above-described configuration. As a result, the inside of the gloves tends to be subject to high temperatures and high humidity. In particular, at high temperatures, for example, in summer, there is a possibility that it may become difficult for a user to work comfortably. Also, the user has to work with his fingertips covered with the glove and therefore it may be difficult for him to do delicate work.

### SUMMARY

The present invention has been devised in light of the circumstances described above. It is an object of the invention to provide a hand lighting tool that allows lighting components to be easily attached to or detached from a user's fingers, allows the light emitted from the lighting components to converge on and efficiently illuminate the area around the user's hand, and also enables the user to do his work comfortably and efficiently.

In order to achieve this object, a hand lighting tool is provided according to an aspect of the invention that includes: a thumb wrapper to be wrapped around a user's thumb so that it can be attached to or detached from the thumb; an index finger wrapper to be wrapped around a user's index finger so that it can be attached to or detached from the index finger; a first lighting component placed on the outside surface of the thumb wrapper at a position close to the index finger when the thumb wrapper is wrapped around the thumb; a second lighting component placed on the outside surface of the index finger wrapper at a position close to the thumb when the index finger wrapper is wrapped around the index finger; and a power supply unit electrically connected to the first lighting component and the second lighting component to supply an electric current to the first lighting component and the second lighting component.

The hand lighting tool having the above-described configuration is designed so that the thumb wrapper with the first lighting component is wrapped around the user's thumb so that it can be attached to or detached from the thumb; and the index finger wrapper with the second lighting component is wrapped around the user's index finger so that it can be attached to or detached from the index finger. As a result, the first lighting component and the second lighting component can be easily removed from the user's fingers merely by taking off the thumb wrapper and the index finger wrapper from the fingers, without removing the entire hand lighting tool from the hand. Also, the first lighting component and the second lighting component can be easily attached to the user's fingers simply by wrapping the thumb wrapper and the index finger wrapper around his fingers. Moreover, when the hand lighting tool according to the invention is attached to the user's hand, the user can do his work with his fingertips exposed. Therefore, the user can do his work in the same manner as he could with his hands bare.

When the hand lighting tool having the configuration described above is attached to the user's hand, the first lighting component placed on the thumb wrapper is located close to the user's index finger and the second lighting component placed on the index finger wrapper is located close to the user's thumb. As a result, when the user works with his hands, the light emitted from the first lighting component and the second lighting component can converge on the area between the thumb and the index finger. Accordingly, it is possible to illuminate the area around the user's hand efficiently. Also, the light emitted from the first lighting component and the second lighting component is prevented from striking other people. Therefore, the user can work without bothering other people.

Furthermore, the thumb wrapper and the index finger wrapper are not configured to cover the entire fingers as fingertip parts of a glove or fingerstalls do, but are configured to wrap around the user's thumb and index finger. As a result, it is possible to prevent an uncomfortable feeling, such as feeling humid at fingers, and the user can work comfortably.

The power supply unit of the hand lighting tool according to an aspect of the invention can include: a power source; a lead wire for electrically connecting the power source, the first lighting component, and the second lighting component; a power source mount on which the power source is placed, and that is attached to the user's arm so that the power source mount can be detached from the user's arm; and a connector that connects the thumb wrapper, the index finger wrapper, and the power source mount, and in which the lead wire is installed. Regarding the hand lighting tool having the above-described configuration, the thumb wrapper and the index finger wrapper are fixed via the connector to the power source mount. Therefore, in addition to the advantageous effects described above, the thumb wrapper and the index finger wrapper will not be lost when they are removed from the fingers.

The power source mount can be attached to the user's wrist and the connector can be attached to the back of the user's hand. The power source can be placed at a position on the back of the user's hand when the power source mount is attached to his wrist. The power source can be placed in the power source mount so that the power source can be attached to or detached from the power source mount. As a result, the power source can be easily replaced.

Moreover, the hand lighting tool according to an aspect of the invention can be configured so that it further includes at least one of: a middle finger wrapper to be wrapped around the user's middle finger so that it can be attached to or detached from the middle finger; a ring finger wrapper to be wrapped around the user's ring finger so that it can be attached to or detached from the ring finger; and a little finger wrapper to be wrapped around the user's little finger so that it can be attached to or detached from the little finger; wherein a third lighting component is placed on the outside surfaces of the middle finger wrapper, the ring finger wrapper, and the little finger wrapper when these wrappers are wrapped around the respective fingers; and wherein the power supply unit is electrically connected to the third lighting component to supply an electric current to the third lighting component. In addition to the advantageous effects described above, the above-described configuration enables an increase or decrease in the number of the lighting components (i.e., control of the quantity of light) depending on, for example, the content of the work or the nature of a workplace. In this configuration, the power supply unit can further include a lead wire for electrically connecting the power source and the third lighting component; and wherein a lead wire for connecting at least one of the middle finger wrapper, the ring finger wrapper, and the little finger wrapper to the power source mount, and electrically connecting the power source to the third lighting component can be installed in the connector.

Furthermore, the thumb wrapper, the index finger wrapper, the middle finger wrapper, the ring finger wrapper, the little finger wrapper, the connector, and the power source mount can be made of a waterproof material. As a result, in addition to the advantageous effects described above, the user can feel safer using the hand lighting tool even when he has to use water in his work.

Also, in the hand lighting tool according to an aspect of the invention, a light shade for covering part of the first lighting component can be placed on the thumb wrapper. Moreover, a light shade for covering part of the second lighting component can be placed on the index finger wrapper. Furthermore, a light shade for covering part of the third lighting component can be placed on at least one of the middle finger wrapper, the ring finger wrapper, and the little finger wrapper.

Since the light shade has a reflecting surface that reflects light, the light emitted from the first lighting component, the second lighting component, and the third lighting component can be reflected so that the reflected light can converge on the area around the user's hand more efficiently.

Since the light shade has a diffusion preventer that prevents light diffusion, the light emitted from the first lighting component, the second lighting component, and the third lighting component can be made to converge on the area around the user's hand more efficiently.

The hand lighting tool according to an aspect of the invention can include a spare part container for accommodating a spare part for the power source. As a result, if the power source (such as a battery) in use reaches the end of its usefulness, a spare power source placed in the spare part container can be used. Also, the user can put the power source whose life has ended, instead of the spare power source, in the spare part container and take it back home.

The position where the spare part container should be formed is not particularly limited, and the spare part container can be formed, for example, at one end of the power source mount.

Also, in the hand lighting tool according to an aspect of the invention, the power source, the first lighting component, and the second lighting component can be connected via a current regulation diode. As a result, the current regulation diode can maintain a constant amount of electric current supplied to the first lighting component and the second lighting component even if a nonstandard battery is set in the hand lighting tool by mistake, or the voltage rises beyond an optimal value due to, for example, hot air caused by sunlight or similar, giving rise to the possibility that an overcurrent may be supplied from the power source to the first lighting component and the second lighting component.

In the hand lighting tool of this invention, the first lighting component and the second lighting component can be easily removed from the fingers merely by taking off the thumb wrapper and the index finger wrapper from the fingers; and the first lighting component and the second lighting component can be easily attached to the fingers merely by wrapping the thumb wrapper and the index finger wrapper around the fingers. When the hand lighting tool having the configuration described above is attached to the user's hand, the first lighting component is located close to the user's index finger and the second lighting component is located close to the user's thumb. As a result, the light emitted from the first lighting component and the second lighting component can converge on the area between the thumb and the index finger. Accordingly, it is possible to illuminate the area around the user's hand efficiently. Furthermore, since this hand lighting tool allows the user to work with his fingertips exposed, the user can do delicate work in the same manner as he could with his hands bare. As a result, it is possible to provide a hand lighting tool that can be easily attached to the user's hand and allow the user to work comfortably and efficiently.

### BRIEF DESCRIPTION OF THE DRAWINGS

FIG. 1 is a plan view of a hand lighting tool according to an embodiment of the present invention.

FIG. 2 shows the internal state of the hand lighting tool shown in FIG. 1.

FIG. 3 is a perspective view of a power source part, a component of the hand lighting tool shown in FIGS. 1 and 2, showing the state where a battery is to be inserted into a battery box.

FIG. 4 is a plan view showing the state where the hand lighting tool shown in FIG. 1 is attached to a left hand.

FIG. 5 is a perspective view of a user's left hand, to which the hand lighting tool shown in FIG. 1 is attached, while doing his work.

FIG. 6 is a perspective view of a user's left hand, to which a hand lighting tool according to another embodiment of the invention is attached, while doing his work.

FIG. 7 is a plan view of a hand lighting tool according to the second embodiment of the invention.

FIG. 8 is an enlarged plan view of part of the hand lighting tool shown in FIG. 7.

FIG. 9 is a cross-sectional view of the part of the hand lighting tool as taken along line IX-IX in FIG. 8.

FIG. 10 is an enlarged plan view of part of a hand lighting tool according to another embodiment of the invention.

FIG. 11 is a cross-sectional view of the part of the hand lighting tool as taken along line XI-XI in FIG. 10.

FIG. 12 is a circuit diagram according to another embodiment of the invention.

### DETAILED DESCRIPTION OF PREFERRED EMBODIMENTS

A hand lighting tool according to preferred embodiments of this invention will be described below with reference to the attached drawings. The embodiments described below are for the purpose of describing this invention, but the invention is not limited only to these embodiments. Accordingly, this invention can be utilized in various ways unless the utilizations depart from the gist of the invention. The embodiments in this specification describe the case where the hand lighting tool is attached to a user's left hand. However, as a matter of course, the hand lighting tool of this invention may be configured so that it can be attached to a user's right hand; and the hand lighting tool may be attached to a user's right hand or to both hands.

### First Embodiment

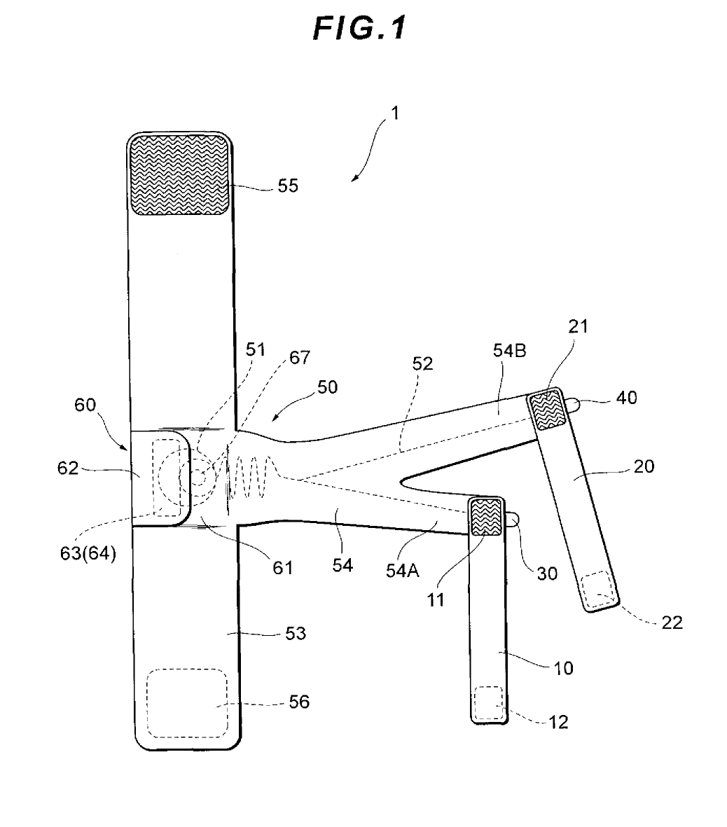

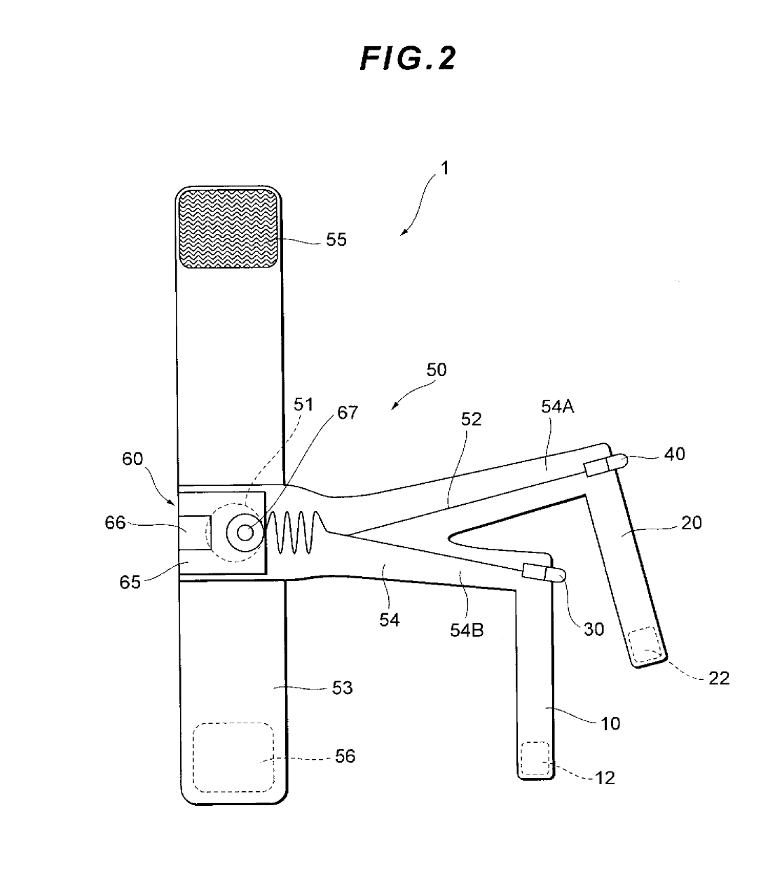

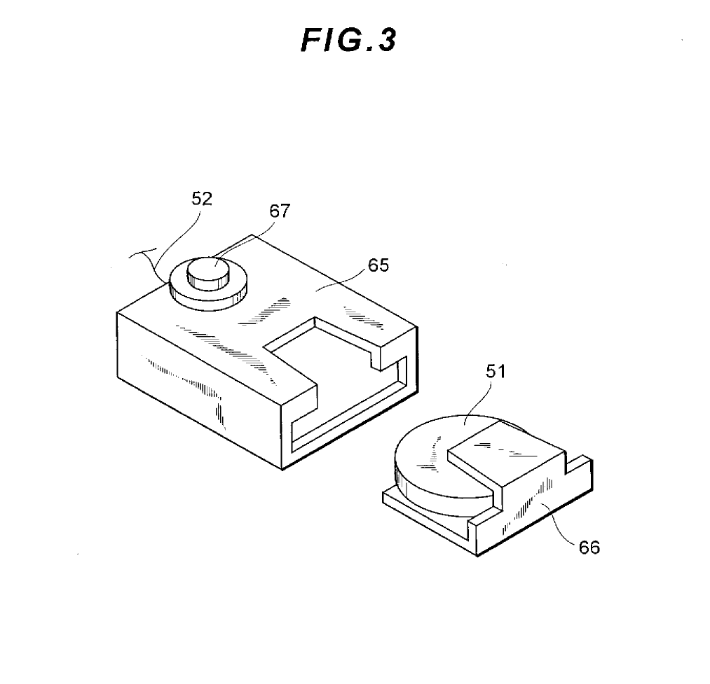

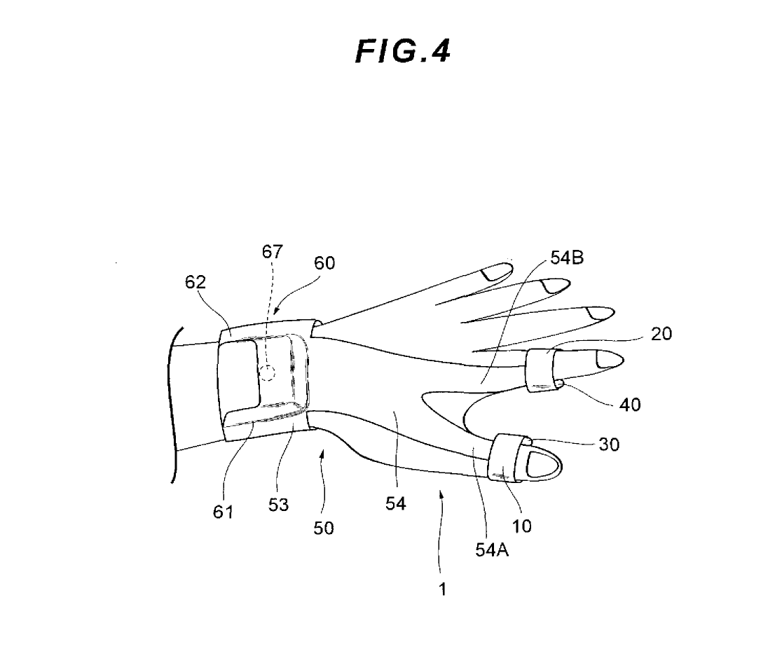

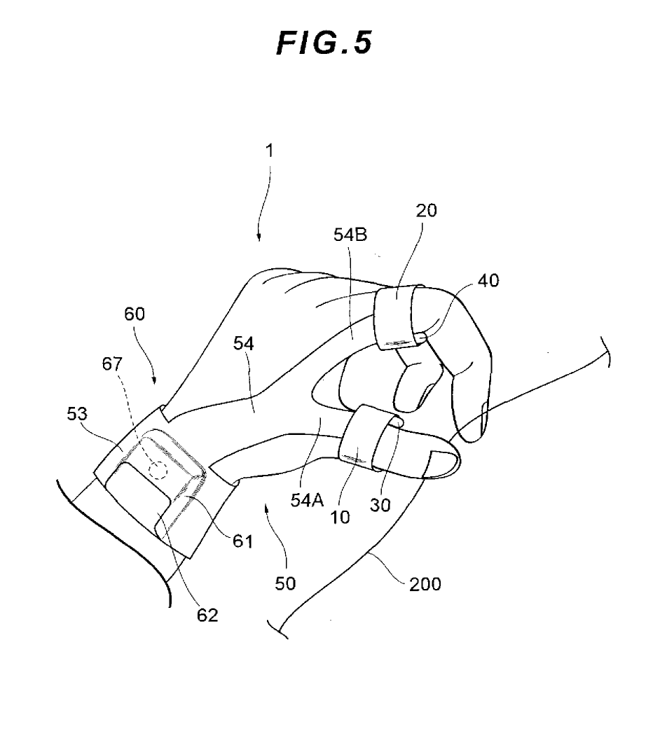

FIG. 1 is a plan view of a hand lighting tool according to the first embodiment of the present invention. FIG. 2 shows the internal state of the hand lighting tool shown in FIG. 1. FIG. 3 is a perspective view of a power source part, a component of the hand lighting tool shown in FIGS. 1 and 2, showing the state where a battery is to be inserted into a battery box. FIG. 4 is a plan view showing the state where the hand lighting tool shown in FIG. 1 is attached to a left hand. FIG. 5 is a perspective view of a user's left hand, to which the hand lighting tool shown in FIG. 1 is attached, while doing his work.

As shown in FIGS. 1 to 5, a hand lighting tool 1 according to the first embodiment includes: a thumb wrapper 10 to be wrapped around a user's thumb so that it can be attached to or detached from the thumb; an index finger wrapper 20 to be wrapped around the user's index finger so that it can be attached to or detached from the index finger; an LED 30 that is the first lighting component placed on the thumb wrapper 10; an LED 40 that is the second lighting component placed on the index finger wrapper 20; and a power supply unit 50 electrically connected to the LEDs 30 and 40 to supply an electric current to the LEDs 30 and 40.

The thumb wrapper 10 is composed of a strap body that is, for example, approximately 1 cm wide and has a length that can be wrapped around a user's thumb. An LED 30 is placed and exposed at one end of this thumb wrapper 10. As shown in FIGS. 4 and 5, the LED 30 is placed on the outside surface of the thumb wrapper 10 at a position close to the user's index finger when the thumb wrapper 10 is wrapped around the user's thumb. Also, a hook fastener 11 is placed on the front side of the thumb wrapper 10 at its one end where the LED 30 is located; and a loop fastener 12 for engaging with the hook fastener 11 is placed on the back side of the other end of the thumb wrapper 10.

The index finger wrapper 20 is composed of a strap body that is, for example, approximately 1 cm wide and has a length that can be wrapped around a user's index finger. An LED 40 is placed and exposed at one end of this index finger wrapper 20. As shown in FIGS. 4 and 5, the LED 40 is placed on the outside surface of the index finger wrapper 20 at a position close to the user's thumb when the index finger wrapper 20 is wrapped around the user's index finger. Also, a hook fastener 21 is placed on the front side of the index finger wrapper 20 at its end where the LED 40 is located; and a loop fastener 22 for engaging with the hook fastener 21 is placed on the back side of the other end of the index finger wrapper 20.

A power supply unit 50 includes: a battery 51 that is a power source; a lead wire 52 for electrically connecting the battery 51 and the LEDs 30 and 40; a power source mount 53 in which the battery is placed, and that is attached to the user's wrist so that the power source mount 53 can be detached from the user's wrist as necessary; and a connector 54 that connects the thumb wrapper 10, the index finger wrapper 20, and the power source mount 53, and in which the lead wire 52 is installed.

A hook fastener 55 is formed at one end of the power source mount 53, while a loop fastener 56 for engaging with the hook fastener 55 is formed at the other end of the power source mount 53. The power source mount 53 can be attached to the user's wrist by wrapping the power source mount 53 around the user's wrist and causing the hook fastener 55 and the loop fastener 56 to engage with each other; and the power source mount 53 can be detached from the user's wrist whenever necessary.

Also, a battery container 60 for accommodating the battery 51 is placed in the generally central part of the power source mount 53. This battery container 60 includes: a pocket 61 formed in the generally central part of the power source mount 53; a cover 62 for opening or closing the pocket 61; a case 65 (see FIG. 3) placed in the pocket 61; and a battery tray 66 (see FIG. 3) used to mount the battery 51 in the case 65 in such a manner that the battery 51 can be inserted into or pulled out of the case 65.

A loop fastener 63 is placed on the outside surface of the pocket 61, while a hook fastener 64 for engaging with the loop fastener 63 is placed on the inside surface of the cover 62. A switch 67 is provided on the top surface of the case 65. After the battery 51 is put in the case 65 by inserting the battery tray 66 into the case 65, and when the switch 67 is turned on, the battery 51 and the LEDs 30 and 40 are electrically connected via the lead wire 52 and the LEDs 30 and 40 light up. When the switch 67 is turned off, the LEDs 30 and 40 turn off. Incidentally, the case 65 is placed in the pocket 61 in advance and the lead wire 52 is electrically connected to the battery 51 placed in the case 65. The hand lighting tool 1 is designed so that the case 65 can be pulled out of the pocket 61 while still connected to the lead wire 52. Also, the case 65 is placed in the pocket 61 so that the switch 67 is located close to the fingertip side.

The connector 54 extends generally perpendicularly to the lengthwise direction of the power source mount 53 from the position where the battery container 60 of the power source mount 53 is located. The top end side of the connector 54 branches into two parts. The thumb wrapper 10 is placed at the top end of one branch part 54A, while the index finger wrapper 20 is placed at the top end of the other branch part 54B. When the hand lighting tool 1 is attached to the user's hand, this connector 54 is attached to the back of the user's hand and the aforementioned battery container 60 is attached to the back of the user's wrist.

The thumb wrapper 10, the index finger wrapper 20, the power source mount 53, and the connector 54 are made of a waterproof material such as material for wet suits.

Next, the specific operation of the hand lighting tool 1 according to the first embodiment will be described. The battery 51 is first set on the battery tray 66, and the battery tray 66 with the battery 51 set thereon is then set in the case 65 which has been placed in the pocket 61 in advance. Subsequently, the cover 62 is placed over the pocket 61 and the loop fastener 63 is made to engage with the hook fastener 64. In order to place the battery tray 66, on which the battery 51 is set, in the case 65, the case 65 may be pulled out of the pocket 61. Since the battery 51 can be attached to or detached from the hand lighting tool 1, if the battery 51 reaches the end of its usefulness, the battery 51 can be easily replaced. If the hand lighting tool 1 is not used for a while, the battery 51 may be removed from the hand lighting tool 1.

Next, in order to attach the hand lighting tool 1, on which the battery 51 is set, to the user's left hand, the power source mount 53 is wrapped around the user's wrist in such a way that the battery container 60 will be located on the back of the user's wrist; and then the hook fastener 55 and the loop fastener 56 are made to engage with each other. Subsequently, the connector 54 is put on the back of the user's hand, the thumb wrapper 10 is wrapped around the user's thumb, and the hook fastener 11 and the loop fastener 12 are made to engage with each other. As a result, the LED 30 is located on the thumb at a position close to the index finger as shown in FIGS. 4 and 5. Then, the index finger wrapper 20 is wrapped around the user's index finger, and the hook fastener 21 and the loop fastener 22 are made to engage with each other. As a result, the LED 40 is located on the index finger at a position close to the thumb as shown in FIG. 4 and FIG. 5. In this way, the hand lighting tool 1 is attached to the user's left hand.

Incidentally, the above-described attachment procedure is just an example. The hand lighting tool 1 may be attached to the user's hand using arbitrary procedures, including: after the thumb wrapper 10 and the index finger wrapper 20 are first attached to the user's thumb and index finger, the power source mount 53 may be then attached to the user's wrist; or the index finger wrapper 20 is first attached to the user's index finger, and the thumb wrapper 10 is then attached to the user's thumb.

After the user attaches the hand lighting tool 1 to his left hand and pushes the switch 67 to turn it on, the LEDs 30 and LED 40 light up. When this happens, the LED 30 is located on the thumb at a position close to the index finger and the LED 40 is located on the index finger at a position close to the thumb as shown in FIG. 5. So, the light emitted from the LEDs 30 and 40 can be made to converge on the area between the thumb and the index finger. Accordingly, it is possible to illuminate the area around the hand. It is also possible to prevent the light emitted from the LEDs 30 and LED 40 from striking other people. Therefore, the user can work without bothering other people. Also, when the hand lighting toot 1 is attached to the user's hand, the user can work with his fingertips exposed. So, the user can do delicate work in the same manner as he could with his hands bare. Furthermore, the thumb wrapper 10 and the index finger wrapper 20 are not configured to cover the entire fingers as fingertip parts of a glove or fingerstalls do, but are configured to wrap around the user's thumb and index finger. As a result, it is possible to prevent an uncomfortable feeling, such as feeling humid at fingers, and the user can work comfortably. Incidentally, FIG. 5 shows an example of the state where the hand lighting tool 1 is attached to a user's hand when the user is fishing at night; and the user is working on a fishing line 200 while having the LEDs 30 and 40 light up.

If the user wants to keep the LEDs 30 and 40 temporarily away from his fingers, for example, when washing his hands, the user may do so by releasing the engagement of the hook fastener 11 with the loop fastener 12, taking off the thumb wrapper 10 from his thumb, releasing the engagement of the hook fastener 21 with the loop fastener 22, and taking off the index finger wrapper 20 from his index finger. In this way, if the user wants to keep the LEDs 30 and 40 temporarily away from his fingers, he does not have to remove the entire hand lighting tool 1 from his hand and it is convenient for him to attach the finger wrappers 10 and 20 back on his hand. Since the LEDs 30 and 40 are mounted on the thumb wrapper 10 and the index finger wrapper 20 respectively and the thumb wrapper 10 and the index finger wrapper 20 are fixed via the connector 54 to the power source mount 53, the user has no need to worry about the possibility of losing the LEDs 30 and 40 when he takes off the thumb wrapper 10 and the index finger wrapper 20 from his fingers. Also, there is no need to worry about the possibility of losing the thumb wrapper 10 and the index finger wrapper 20.

When the user wants to resume working, all he needs to do is to attach the thumb wrapper 10 and the index finger wrapper 20 to his respective fingers.

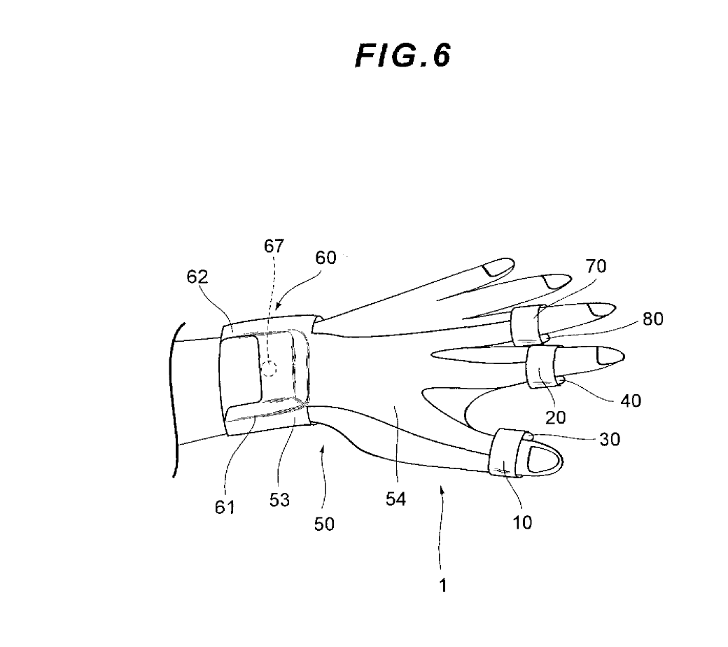

The first embodiment described the hand lighting tool 1 equipped with the thumb wrapper 10 and the index finger wrapper 20. However, the configuration of the hand lighting tool of this invention is not limited to this example, and the hand lighting tool may further include, for example, a middle finger wrapper 70 to be wrapped around a user's middle finger as shown in FIG. 6, in such a way that the middle finger wrapper 70 can be attached to or detached from the middle finger. Incidentally, an LED 80 is placed on the outside surface of the middle finger wrapper 70 at a position close to the user's thumb when the middle finger wrapper 70 is wrapped around the user's middle finger; and a hook fastener (not shown in the drawing) and a loop fastener (not shown in the drawing) for engaging with the hook fastener are provided on the middle finger wrapper 70 in the same manner as on the index finger wrapper 20. The middle finger wrapper 70 is connected via the connector 54 to the power source mount 53, and the LED 80 is electrically connected via the lead wire 52 to the battery 51.

The hand lighting tool of this invention may also include: a ring finger wrapper (not shown in the drawing) to be wrapped around the user's ring finger so that the ring finger wrapper can be attached to or detached from the ring finger; and/or a little finger wrapper (not shown in the drawing) to be wrapped around the user's little finger so that the little finger wrapper can be attached to or detached from the little finger. The ring finger wrapper (not shown in the drawing) and the little finger wrapper (not shown in the drawing) may be configured so that an LED is placed on the outside surface of each finger wrapper at a position close to the user's thumb when the relevant finger wrapper is wrapped around the relevant finger.

Incidentally, a hand lighting tool for a right hand and the hand lighting tool 1 according to the first embodiment are configured in a bilaterally symmetric manner.

### Second Embodiment

Next, a hand lighting tool 2 according to a second embodiment of the invention will be described with reference to the following drawings.

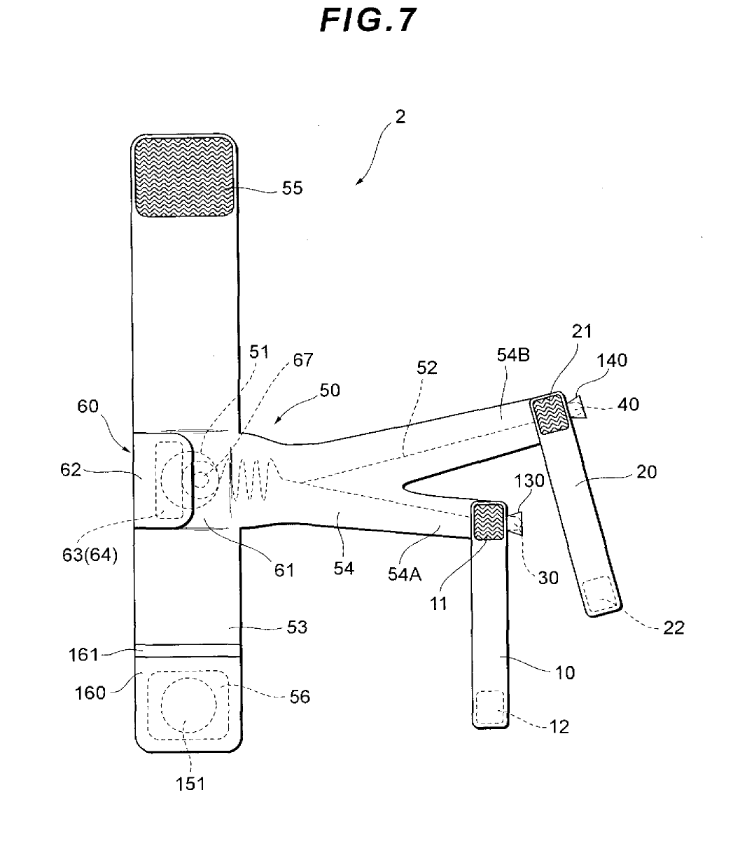

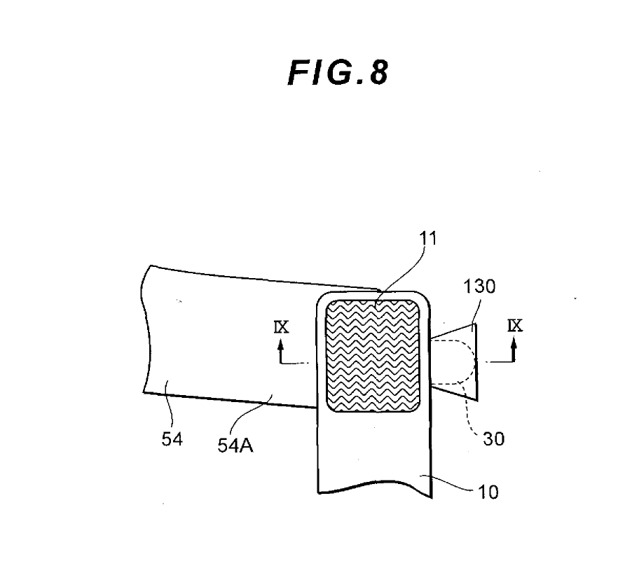

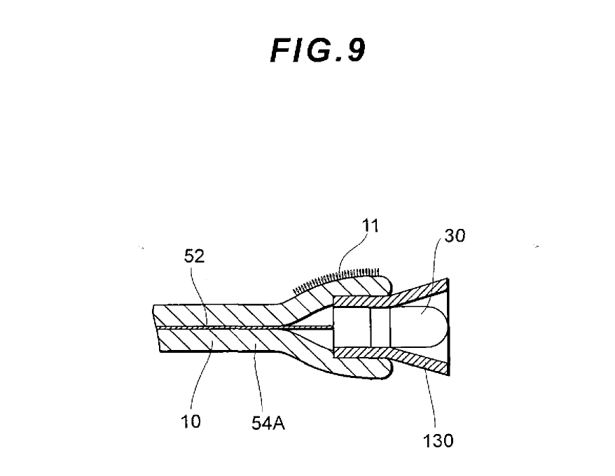

FIG. 7 is a plan view of a hand lighting tool according to the second embodiment of the invention. FIG. 8 is an enlarged plan view of part of the hand lighting tool shown in FIG. 7. FIG. 9 is a cross-sectional view of that part of the hand lighting tool as taken along line IX-IX in FIG. 8. The elements used in the second embodiment the same as those explained in the first embodiment are given the same reference numerals as in the first embodiment, and any detailed description of them has been omitted.

As shown in FIGS. 7 to 9, the main difference between the hand lighting tool 2 according to the second embodiment and the hand lighting tool 1 according to the first embodiment is that a light shade 130 for covering part of the LED 30 is placed on the thumb wrapper 10, and a light shade 140 for covering part of the LED 40 is placed on the index finger wrapper 20, and a spare part container 160 for accommodating a standby battery 151 (a spare part) is formed at one end of the power source mount 53. Since the light shade 130 and the light shade 140 are similar components, the light shade 130 will be described below.

The base end portion of the light shade 130 corresponding to the base end side of the LED 30 is hollow and of a generally cylindrical shape, and the top end portion of the light shade 130 is hollow and of a generally conical shape with a diameter increasing toward the top end of the LED 30. The base end side of the LED 30 is inserted into the hollow portion formed in the base end side of the light shade 130, and the LED 30 and the light shade 130 are fixed to the thumb wrapper 10. The inside surface of the top end portion of the light shade 130 constitutes a reflecting surface that reflects light. The reflecting surface reflects light emitted from the LED 30 and makes the reflected light illuminate the area around the user's hand more efficiently.

A spare part container 160 is formed by sewing a pocket cloth of a size capable of receiving a standby battery 151 inside the pocket, on one end of the power source mount 53. The spare part container 160 has a battery opening 161.

In order to use the hand lighting tool 2 having the above-described configuration (the hand lighting tool 2 is to be attached to a user's left hand in the second embodiment), the battery 51 is first set on the battery container 60 in the same manner as in the first embodiment, and the hand lighting tool 2 is attached to the user's left hand so that the LED 30 is located on the user's thumb at a position close to his index finger and the LED 40 is located on the user's index finger at a position close to his thumb (see FIGS. 4 and 5). Also, the standby battery 151 is put in the spare part container 160 (see FIG. 7).

After the user attaches the hand lighting tool 2 to his left hand and pushes the switch 67 to turn it on, the LED 30 and LED 40 light up. When this happens, the LED 30 is located on the thumb at a position close to the index finger and the LED 40 is located on the index finger at a position close to the thumb as shown in FIG. 5. So, the light emitted from the LEDs 30 and 40 can be made to converge on the area between the thumb and the index finger. Also, the light emitted from the LED 30 is reflected by the light shade 130 and the light emitted from the LED 40 is reflected by the light shade 140. As a result, it is possible to illuminate the area around the hand efficiently and even more brightly.

In addition, this hand lighting tool 2) like the hand lighting tool 1 according to the first embodiment, can prevent the light emitted from the LEDs 30 and 40 from striking other people. Therefore, the user can work without bothering other people. Also, when the hand lighting tool 2 is attached to the user's hand, the user can work with his fingertips exposed. As a result, the user can do delicate work in the same manner as he could with his hands bare. It is also possible to prevent an uncomfortable feeling, such as feeling humid at the fingers, and the user can work comfortably.

If the battery 51 in use drains and reaches the end of its usefulness, the user may follow the inverse procedure of the aforementioned procedure, that is, taking the used battery 51 out of the battery container 607 taking the new battery 151 out of the spare part container 160, and then setting the new battery 151 in the battery container 60 in the same manner described above. Incidentally, the used battery 51 can be temporarily stored in the spare part container 160 and be later disposed of at a regular disposal location.

If the user wants to keep the LEDs 30 and 40 temporarily away from his fingers, he may do so in the same manner as in the first embodiment by taking off the thumb wrapper 10 and the index finger wrapper 20 from the respective fingers. If the user wants to resume working, all he needs to do is to attach the thumb wrapper 10 and the index finger wrapper 20 to the respective fingers in the same manner as described above.

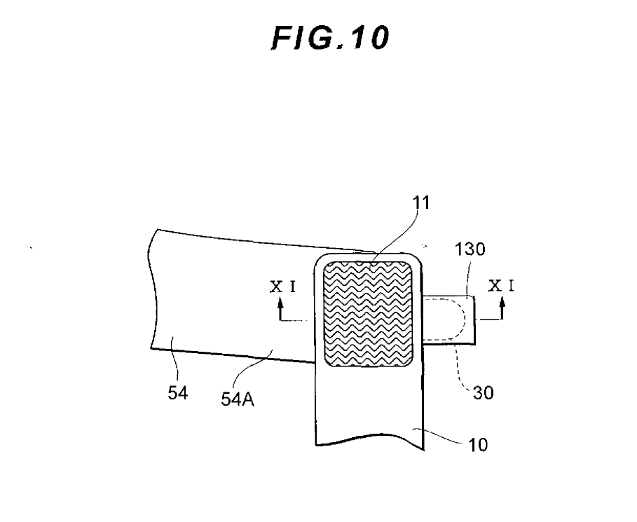

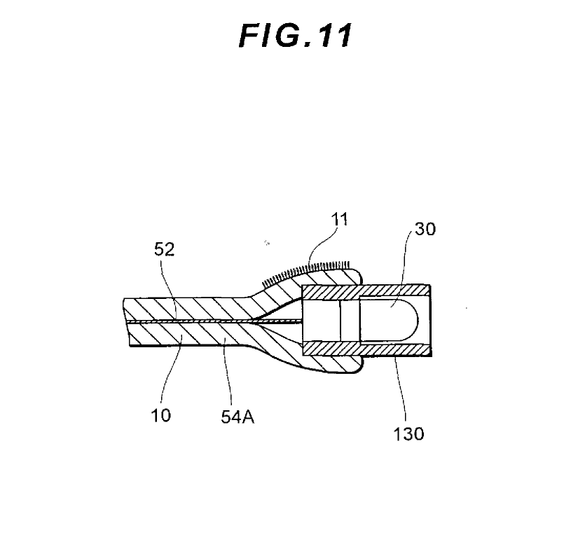

The second embodiment described the case where the light shade 130, 140, which is of a generally conical shape having a wide top end side. However, the shape of the light shade 130, 140 is not limited to this example, and their top end portion may be hollow and of a generally cylindrical shape as shown in FIGS. 10 and 11. In this case, the generally cylindrical portion of the light shade 130, 140 on its top end side constitutes a diffusion preventer that prevents light diffusion. As a result, it is possible to prevent diffusion of the light emitted from the LEDs 30 and 40. Therefore, it is possible to make the light converge on the area around the user's hand more efficiently. Also, in this configuration, the inside surface of the light shade 130, 140 may constitute the reflecting surface that reflects the light.

Moreover, the second embodiment described the spare part container 160 formed at one end of the power source mount 53. However, the location of the spare part container 160 is not limited to this example, and the spare part container 160 may be formed at other locations as necessary.

The hand lighting tool 2 according to the second embodiment may further include, like the hand lighting tool shown in FIG. 6, the middle finger wrapper 70 to be wrapped around the user's middle finger so that the middle finger wrapper 70 can be attached to or detached from the middle finger; and a light shade similar to the light shades 130 and 140 may be provided on the middle finger wrapper 70 to cover at least part of an LED 80 placed on the middle finger wrapper 70. Also, the hand lighting tool 2 according to the second embodiment, like the hand lighting tool 1 according to the first embodiment, may include: a ring finger wrapper (not shown in the drawing) to be wrapped around the user's ring finger so that the ring finger wrapper can be attached to or detached from the ring finger; and/or a little finger wrapper (not shown in the drawing) to be wrapped around the user's little finger so that the little finger wrapper can be attached to or detached from the little finger. The ring finger wrapper (not shown in the drawing) and the little finger wrapper (not shown in the drawing) may be configured so that an LED is placed on the outside surface of each finger wrapper at a position close to the user's thumb when the relevant finger wrapper is wrapped around the relevant finger.

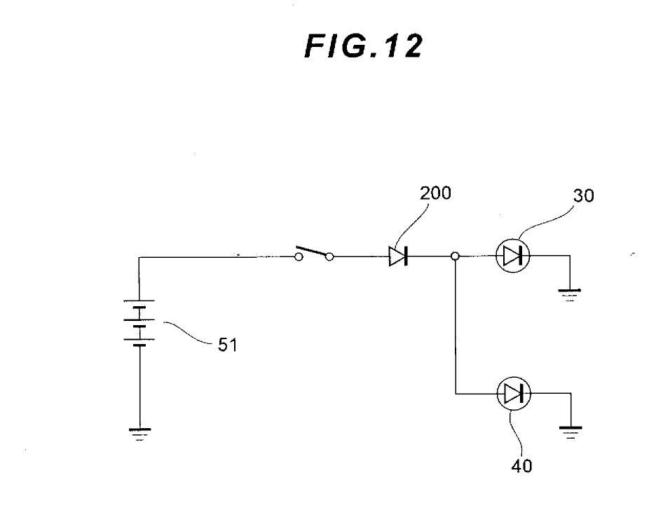

Furthermore, as another embodiment shown in FIG. 12, the power source (the battery 51), the first lighting component (LED 30), and the second lighting component (LED 40) may be connected via a current regulation diode 200 (a protection diode). As a result, the current regulation diode 200 can maintain a constant amount of an electric current supplied to the LEDs 30 and 40 even if a nonstandard battery is set in the hand lighting tool by mistake, or the voltage rises beyond an optimal value due to, for example, hot air caused by sunlight or similar, giving rise to the possibility that an overcurrent may be supplied from the battery 51 to the LEDs 30 and 40. If the third lighting component (LED 80) is provided, it should be understood that the battery 51 and the third lighting component (LED 80) may also be connected via the current regulation diode 200 (protection diode).

What is claimed is:

1. A hand lighting tool comprising:
a thumb wrapper to be wrapped around a user's thumb so that it can be attached to or detached from the thumb;
an index finger wrapper to be wrapped around a user's index finger so that it can be attached to or detached from the index finger;
a first lighting component placed on the outside surface of the thumb wrapper at a position close to the index finger when the thumb wrapper is wrapped around the thumb;
a second lighting component placed on the outside surface of the index finger wrapper at a position close to the thumb when the index finger wrapper is wrapped around the index finger; and
a power supply unit electrically connected to the first lighting component and the second lighting component to supply an electric current to the first lighting component and the second lighting component.

2. The hand lighting tool according to claim 1, wherein the power supply unit includes:
a power source;
a lead wire for electrically connecting the power source, the first lighting component, and the second lighting component;
a power source mount on which the power source is placed, and that is attached to the user's arm so that the power source mount can be detached from the user's arm, and
a connector that connects the thumb wrapper, the index finger wrapper, and the power source mount, and in which the lead wire is installed.

3. The hand lighting tool according to claim 2, wherein the power source mount is attached to the user's wrist and the connector is attached to the back of the user's hand.

4. The hand lighting tool according to claim 3, wherein the power source is placed at a position on the back of the user's hand when the power source mount is attached to his wrist.

5. The hand lighting tool according to claim 2, wherein the power source is placed in the power source mount so that the power source can be attached to or detached from the power source mount.

6. The hand lighting tool according to claim 1, further comprising at least one of: a middle finger wrapper to be wrapped around the user's middle finger so that it can be attached to or detached from the middle finger; a ring finger wrapper to be wrapped around the user's ring finger so that it can be attached to or detached from the ring finger; and a little finger wrapper to be wrapped around the user's little finger so that it can be attached to or detached from the little finger,
wherein a third lighting component is placed on the outside surfaces of the middle finger wrapper, the ring finger wrapper, and the little finger wrapper when these wrappers are wrapped around the respective fingers; and
wherein the power supply unit is electrically connected to the third lighting component to supply an electric current to the third lighting component.

7. The hand lighting tool according to claim 6, wherein the power supply unit further includes a lead wire for electrically connecting the power source and the third lighting component; and
wherein a lead wire for connecting at least one of the middle finger wrapper, the ring finger wrapper, and the little finger wrapper to the power source mount, and electrically connecting the power source to the third lighting component is installed in the connector.

8. The hand lighting tool according to claim 6, wherein the thumb wrapper, the index finger wrapper, the middle finger wrapper, the ring finger wrapper, the little finger wrapper, the connector, and the power source mount are made of a waterproof material.

9. The hand lighting tool according to claim 1, wherein a light shade for covering part of the first lighting component is placed on the thumb wrapper.

10. The hand lighting tool according to claim 1, wherein a light shade for covering part of the second lighting component is placed on the index finger wrapper.

11. The hand lighting tool according to claim 6, wherein a light shade for covering part of the third lighting component is placed on at least one of the middle finger wrapper, the ring finger wrapper, and the little finger wrapper.

12. The hand lighting tool according to claim 9, wherein the light shade has a reflecting surface that reflects light.

13. The hand lighting tool according to claim 9, wherein the light shade has a diffusion preventer that prevents light diffusion.

14. The hand lighting tool according to claim 5, further comprising a spare part container for accommodating a spare part for the power source.

15. The hand lighting tool according to claim 14, wherein the spare part container is formed at one end of the power source mount.

16. The hand lighting tool according to claim 2, wherein the power source, the first lighting component, and the second lighting component are connected via a current regulation diode.
